(19) United States
(12) Patent Application Publication
(10) Pub. No.: US 2004/0089828 A1
(43) Pub. Date: May 13, 2004

(54) Conduit clamp

(76) Inventor: Albert A. Werth, Kewadin, MI (US)

Correspondence Address: ANDREW R. BASILE, Young & Basile, P.C., Suite 624, 3001 West Big Beaver Road, Troy, MI, 48084, US

(21) Appl. No.: 10/687,904

(22) Filed: Oct. 17, 2003

Related U.S. Application Data
(60) Provisional application No. 60/419,350, filed on Oct. 18, 2002.

(51) Int. Cl. F16K 7/04

(52) U.S. Cl. 251/10

(57) ABSTRACT

A conduit clamp for selectively opening and closing the fluid path of a tube includes an upper and lower member pivotally connectable to each other. The upper member has a depression on an upper surface to allow for manual activation for opening and closing the conduit clamp. The lower member has a pair of opposing walls with a cam race formed on the interior surface of each wall for receiving and moving laterally extending pins on the upper member as the conduit clamp is depressed into the locked and closed position and depressed again to be in the open position. The cam race forms a pin bottom stop position, a pin lock position and a pin return ramp position for each laterally extending pin.

This application claims priority of U.S. Provisional Patent Application No. 60/419,350 filed on Oct. 18, 2002.

### FIELD OF THE INVENTION

This invention relates to a conduit clamp for selectively opening and closing the fluid flow in a resilient tubing.

### BACKGROUND OF THE INVENTION

Flexible tubing made of plastic or rubber is widely used in the medical, pharmaceutical, biopharmaceutical, food and beverage, and other laboratory environments. In many instances during the conveying of fluids through the flexible tubing, it is desirable to close and stop the flow of the fluid through the tube. Conduit clamps in the prior art contained undesirable features. Many clamps of the prior art required that the clamp be installed onto the tube only at the ends which required the clamp being threaded from the end of the tube to its desired location. Other undesirable features include difficulty to lock the clamp into the closed position and difficulty to pry the clamp open again. It is therefore desirable to provide a conduit clamp that can be easily opened and closed with only a push button finger pressure.

### SUMMARY OF THE INVENTION

The present invention addresses the aforementioned concerns by providing a conduit clamp for selectively restricting or closing the fluid path in a hollow tube. The conduit clamp has a two-piece construction having an upper member and a lower member releasibly individually connectible to each other for connection around the tube. The upper member has laterally extending pins for disposition in cam races formed on interior surfaces of the lower member wherein the cam races guide the extending pins during the movement between the open position and the closed position of the conduit clamp.

In another aspect of the invention, the lower member has a U-shaped formation for providing a pathway for the tube.

In yet another aspect of the invention, each laterally extending pin is integrally connected to a resilient leg extending from an upper portion of the upper member, and a rib connects the resilient legs together.

In yet another aspect of the invention, the upper member has a center projection for clamping the tube against the lower member. The lower member has a U-shaped formation with a center inner floor portion. The floor has a rib formation positioned for meeting the center projection of the upper member for closing the fluid path of the tube.

In yet another aspect of the invention, each cam race in the interior surface of the lower member has a pin lock stop position, a pin bottom stop position, and a pin return ramp position.

### BRIEF DESCRIPTION OF THE DRAWINGS

The description herein makes reference to the accompanying drawings wherein like reference numerals refer to like parts throughout the several views, and wherein:

FIG. 1 is a perspective view of the conduit clamp of the present invention with an upper and lower member connected together in an open position;

FIG. 2 is a perspective view of the conduit clamp in a closed position;

FIG. 3 is a perspective view showing the top portion of the upper member;

FIG. 4 is a perspective view showing the bottom portion of the upper member;

FIG. 5 is a side elevational view of the upper member;

FIG. 6 is a end elevational view of the upper member;

FIG. 7 is a sectional view of a side interior wall of the lower member;

FIG. 8 is a perspective view of the lower member;

FIG. 9 is a perspective sectional view of the conduit clamp in an open position with a tube therein;

FIG. 10 is a perspective sectional view of the conduit clamp in the closed position closing a tube;

FIGS. 11a-11d are schematic views showing various movements of the conduit clamp as it opens and closes;

FIG. 12 is a perspective view of the upper member having a spring member according to the present invention;

FIG. 13 is a side elevational view of the upper member shown in FIG. 12;

FIG. 14 is a perspective view of the upper member having an alternative embodiment of the spring member;

FIG. 15 is a side elevational view of the upper member shown in FIG. 14;

FIG. 16 is an end elevational view of the upper member shown in FIG. 14;

FIG. 17 is a perspective view of the lower member showing the alternative embodiment of the spring member in phantom; and

FIG. 18 is an exploded view showing the upper and lower members of the conduit clamp and the alternative embodiment of the spring member.

### DESCRIPTION OF THE PREFERRED EMBODIMENT

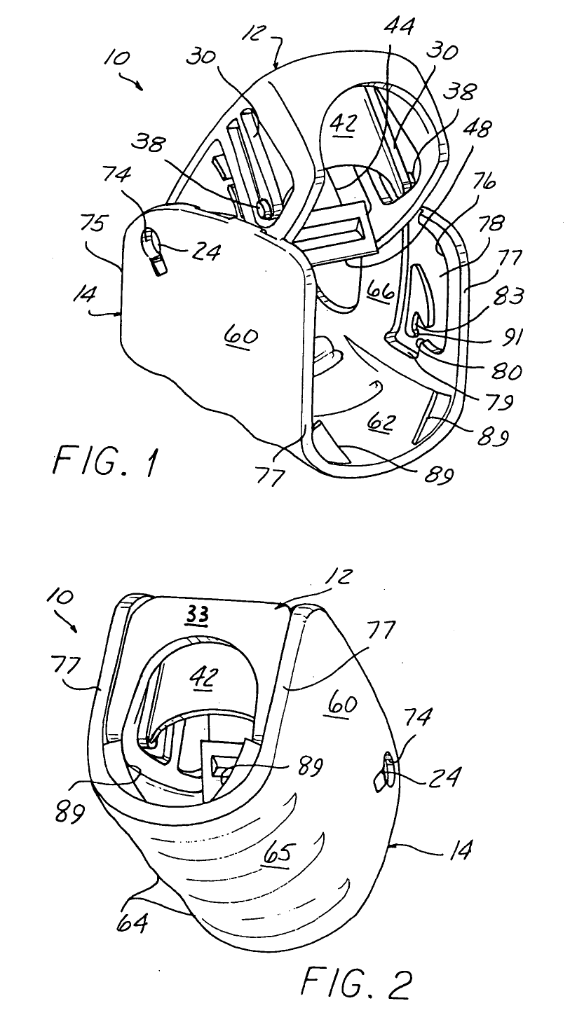

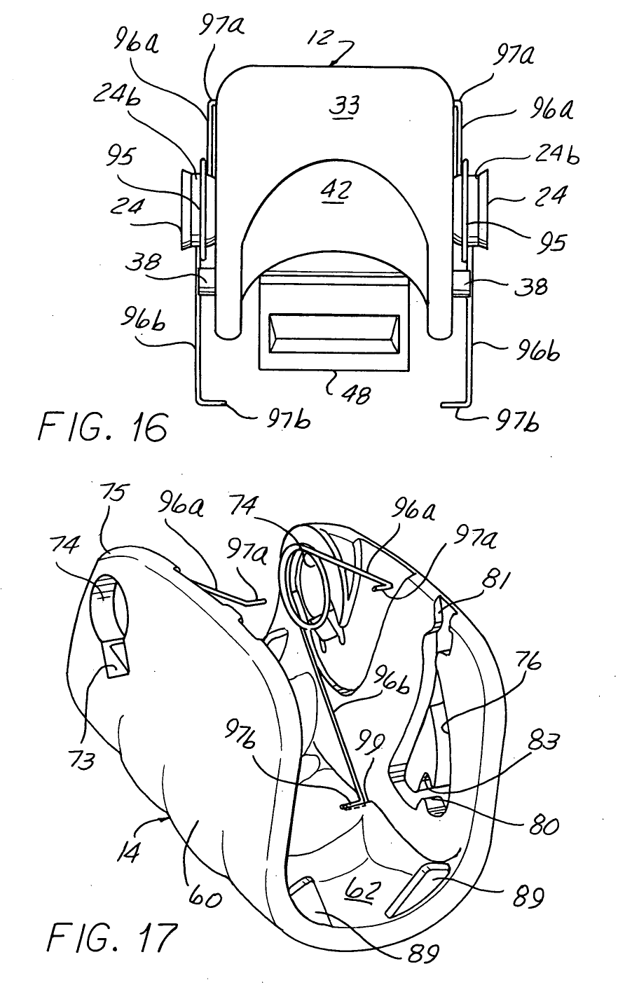

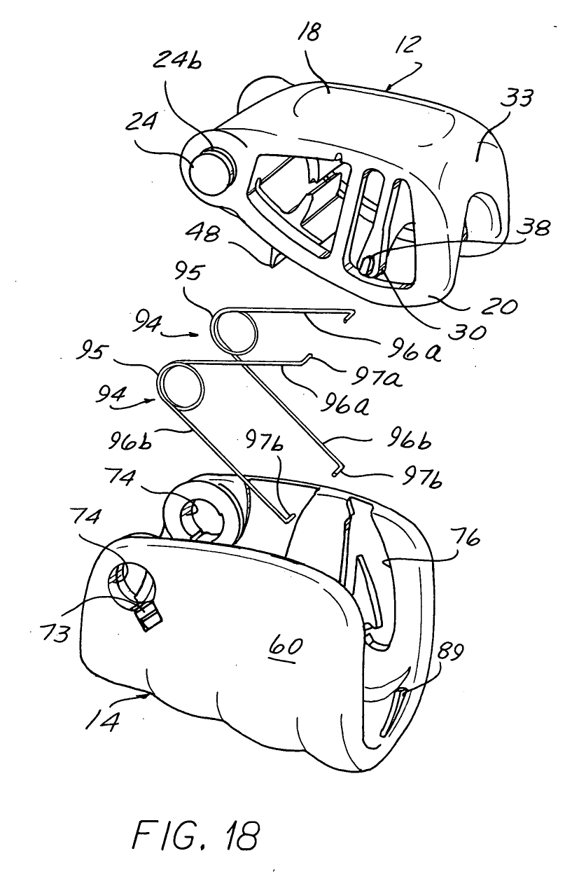

With reference to the FIGS. 1-10, and 12-18 a conduit clamp 10 is provided for pinching and/or closing the fluid path of a tube 100. Although the conduit clamp 10 of the present invention can be used in various environments, the conduit clamp 10 is most beneficial in the medical or pharmaceutical field for selectively controlling the flow of fluid from or to the patient.

The assembled conduit clamp 10 is shown in FIGS. 1 and 2. The conduit clamp 10 of the present invention can selectively be placed on a tube 100 either before or after the assembly of the tube 100 in its environment.

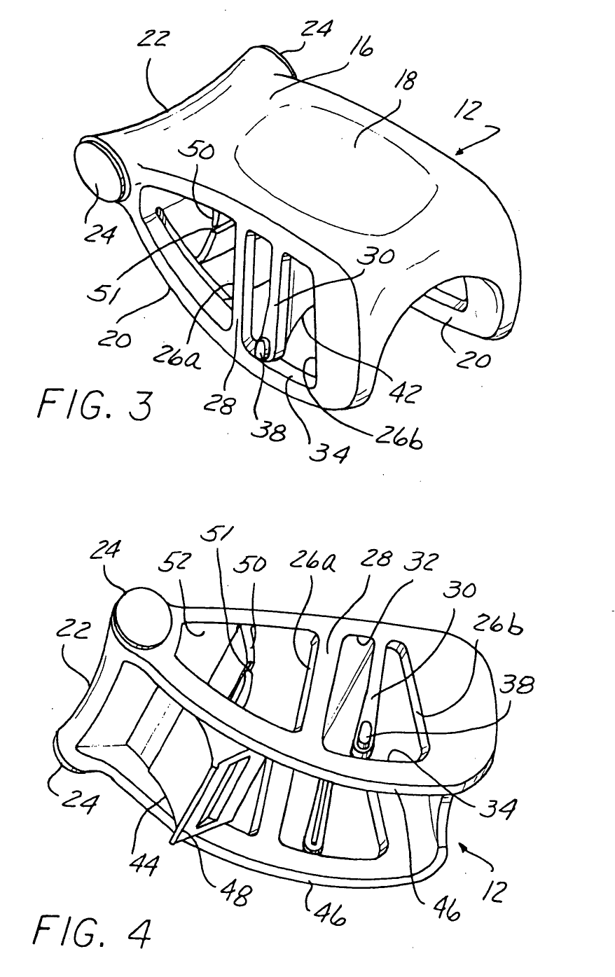

The conduit clamp 10 is a two-piece device including an upper member 12 and a lower member 14. The upper and lower members 12, 14 respectively, can be connected together directly onto and around the tube 100. The upper member 12 is shown separated from the lower member 14 in FIGS. 3-6. The upper member 12 has essentially a U-shaped configuration with an upper surface 16 and two sidewalls 20. The exposed upper surface 16 of the upper member 12 has a shallow depression 18 defining a placement for a finger or thumb when closing and opening the conduit clamp 10. The upper member 12 has a pivot end 22 with a cylindrical formation 22. The pivot end 22 is the point of connection of the upper member 12 to the lower member 14. Each lateral end 24 of the cylindrical formation 22 is adjacent to a side wall 20. A conical-shaped or disc-shaped lobe 24 is formed on each lateral end of the cylindrical formation. The lobes 24 extend laterally beyond the sidewalls 20 for connection to the lower member 14 as discussed hereinafter.

Sidewalls 20 are adjacent to and contiguously formed with the upper surface 16. Each side wall 20 is a mirror image of the other, and therefore only one side wall 20 will be discussed. The side wall 20 of the upper member 12 has an open configuration defined by a pair of windows 26a, 26b formed therein and divided by a center bar 28. A first window provides 26a an access for eliminating the steel portions of the mold during the manufacturing process. The second window 26b includes a leg 30 extending from the upper surface 32 of the window 26b adjacent to the upper surface 16 of the upper member 12. The leg 30 extends downwardly through the center of the second window 26b and terminates before the lower surface 34 of the second window 26b. At the lower free end 36 of each leg 30, an outwardly extending pin 38 is formed thereon.

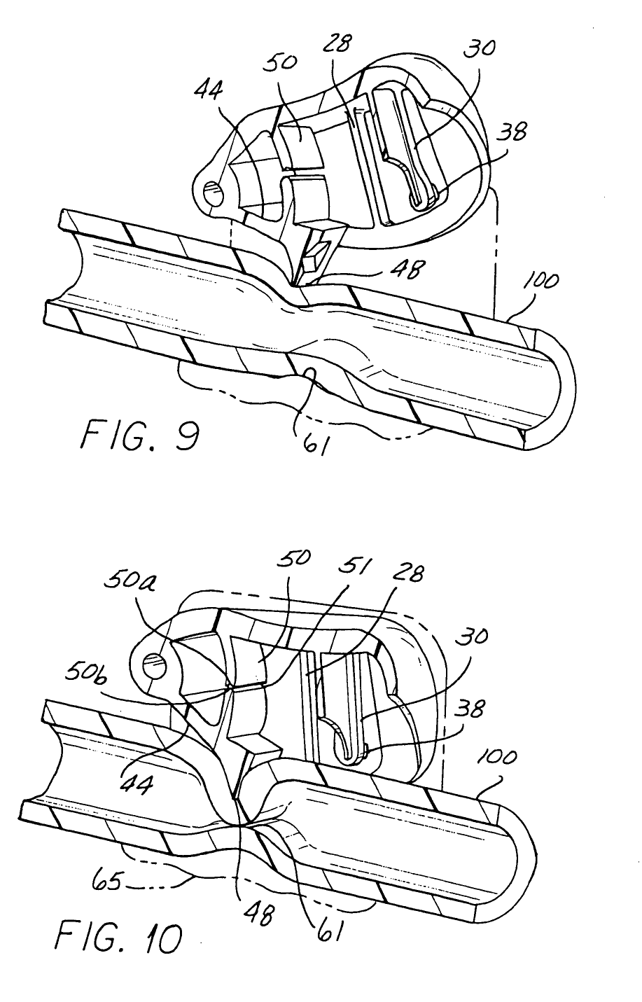

The outwardly extending pins 38 on each of the legs 30 are positioned and formed to move within a cam race 76 formed in the lower member 14 as will be discussed hereinafter. The leg 30 is attached to the side wall 20 only at its upper end 40 to provide flexibility during movement of the pin 38 through the cam race 76. A rib 42 extending laterally from side wall 20 to side wall 20 connects the two legs 30 together. Because the legs 30 have no strength themselves, the rib 42 provides strength to the legs 30 and also facilitates the spring tension of the legs 30. The rib 42 between the two legs 30 has an arch formation to provide clearance for the tube 100, as shown in FIGS. 9 and 10.

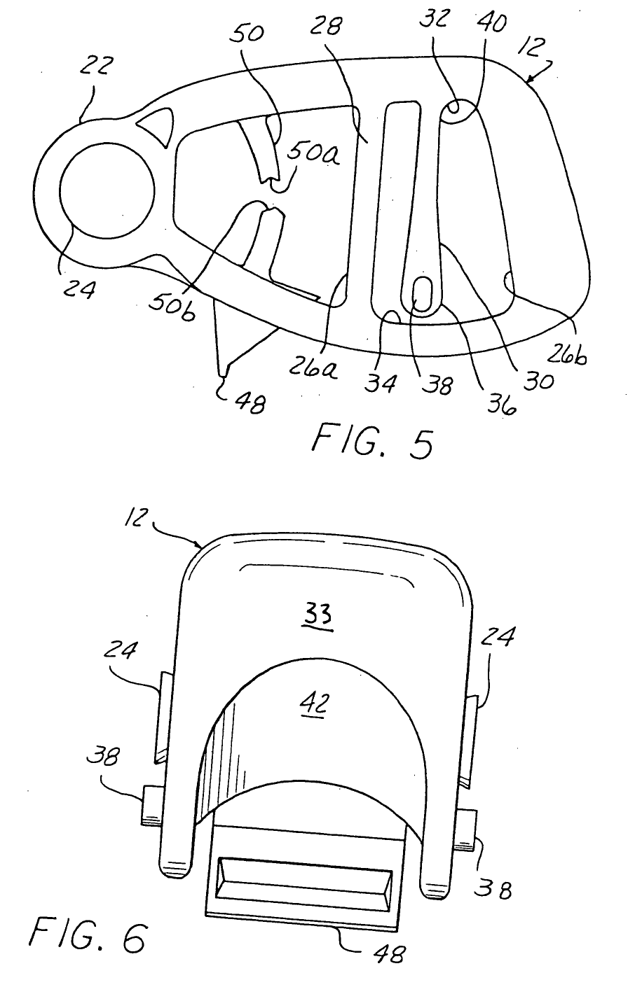

A center projection 44 is connected to the pivot end 22 of the upper member 12 and extends laterally between the two inner surfaces of the sidewalls 20. The projection 44 further extends along the inner surfaces of the side wall 20 and partially extends below the lower surface 46 of each side wall 20. The projection 44 terminates and forms a laterally extending ridged portion 48 between the two inner surfaces of the sidewalls 20. The projection 44 and its ridged portion 48 are not connected to the sidewalls 20 so that the projection 44 and its associated ridged portion 48 is allowed to flex vertically relative to the two sidewalls 20. The ridged portion 48 of the projection 44 pinches the tube 100 closed when the conduit clamp 10 is in the closed position. A C-spring 50, defined as a discontinuous curved section of material, extends between the inner top surface 52 of the upper member 14 and the projection 44 and is connected thereto. A small gap 51 is formed between the two disconnected, curved sections forming the C-spring 50. The C-spring 50 allows a higher load to be applied to the upper surface 16 to close and lock the conduit clamp 10. The C-spring 50 further provides resiliency to the projection 44. When a load is placed on either the upper surface 16 of the upper member 12 of the conduit clamp 10 or when a load is placed on the ridge portion 48 of the projection when pinching a tube 100, the two disconnected portions of the C-spring 50 move together to reduce the gap 51. As can be seen in the Figures and especially FIG. 5, the disconnected portions of the C-spring have complementary ends 50a, 50b to guide the movement of the C-spring 50 when a load is applied.

On the opposite end of the upper member 12 from the pivot end 22 is a front wall 33 which is adjacent to and contiguously formed with upper surface 16 and sidewalls 20. The front wall 33 has a U-shaped configuration for receiving a portion of the tube 100 therethrough.

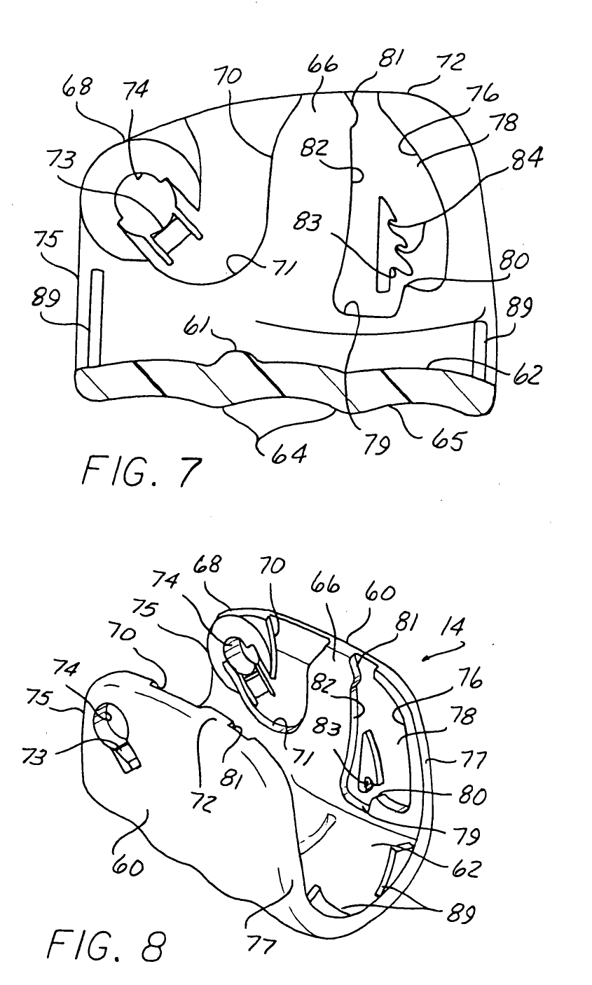

FIGS. 7 and 8 show the lower member 14 of the conduit clamp 10. The lower member 14 has a U-shaped configuration with a pair of sidewalls 60 meeting with a bottom interior surface 62. The bottom interior surface 62 of the lower member 14 includes at least one laterally extending bump 61 protruding upward between the two sidewalls 60 for cooperating with the laterally extending ridged portion 48 of the center projection 44 to close the fluid flow in the tube 100. Multiple bumps 64 may also be provided along the bottom exterior surface 65 as finger grips.

Each side wall 60 is a mirror image of the opposing side wall 60, and therefore only one side wall 60 will be discussed. FIG. 7 shows an interior side wall surface 66 of the lower member 14. Proximate to an upper corner 68 of the side wall 60, the inner surface 66 has a shallow groove 70 starting at the upper surface 72 of the side wall 60. The path of the shallow groove 70 has a curved portion 71 that terminates at an aperture 74 for receiving the conical or disc-shaped lobes 24 of the upper member 12. The apertures 74 are adjacent to the pivoting end 75 of the lower member 14. The apertures 74 are essentially circular having a notch with an extending wedge 73 adjacent the shallow groove 70 for facilitating the entry of the conical or disc-shaped lobe 24 into the aperture 74. Each extending wedge 73 grips one edge of each lobe 24 to secure the lobe 24 in the aperture 74 of the lower member 14.

Spaced from the shallow groove 70 and adjacent the leading edge 77 of the lower member 14, there is located another shallow groove or cam race 76 for receiving the pin 38 on the leg 30 during movement of the upper member 12 relative to the lower member 14 when the two members are connected. The cam race 76 defines the path of movement of the pin 38 relative to the lower number 14 when downward pressure is applied to the upper member 12. Looking first at FIG. 8, the shape of the cam race 76 includes a downward arcuate curved portion 78 terminating at a slight inclined portion of the path terminating at a single bump 80 therein. After the bump 80, the path extends abruptly downward to a generally horizontal portion 79. The horizontal portion 79 is at a level closer to the bottom interior surface 62 than the aforementioned slight incline portion for reasons discussed infra. The cam cam race 76 also includes a vertically straight path portion 82 for the return of the pin 38 relative to the lower member 14 when the conduit clamp 10 is opened. As can be seen in FIGS. 7 and 8, the cam race 76 has an entry path 81 for providing the pin 38 with access to the cam race 76 when the conduit clamp 10 is completely open. As will be discussed further in detail hereinafter, when the conduit clamp 10 is closed, the pin 38 is maintained in the notch 83 formed at the single bump 80 of the cam race 76.

As an alternative, the cam race 76 may include ratchet steps 84, along the arcuate curved portion 78. The rachet steps 84 allow for partial closure of the tube 100 when the pin 38 is maintained within each step 84. Continued pressure on the upper surface 16 of the upper member 12 will move the pin 38 to each successive ratchet step 84.

The upper member 12 can be connected to the lower member 14 either before the conduit clamp 10 is threaded onto the tube 100, or the tube 100 may be placed between the sidewalls 60 and between the angle notches 89 which form a pathway of the lower member before the upper member 12 is connected to the lower member 14. In either case, the upper member 12 is connected to the lower member 14 by moving the lobes 24 of the upper member 12 through the shallow grooves 70 in the sidewalls 60 of the lower member 14 until the lobes 24 are disposed within the apertures 74 of the lower member 14. The extending wedge 73 grips an edge of the lobes 24 to maintain the lobes 24 within the apertures 74. When the lobes 24 are positioned within the aperture 74, the pins 38 of the upper member 12 are positioned above the cam race 76 or in the entry access 81 of the cam race 76 formed on the inner side wall surface 66 of the lower member 14.

FIGS. 9 and 10 show sectioned portions of the conduit clamp 10 with a tube 100 located therein. FIG. 9 shows the conduit clamp 10 in an open position with the ridged portion 48 of the center projection 44 positioned above the tube 100. When the upper member 12 is depressed by the user, the upper member 12 moves downwardly so that the cylindrical portion 48 of the center projection 44 squeezes the tube 100 closed against the bump 61 in the bottom surface 62 of lower member 14.

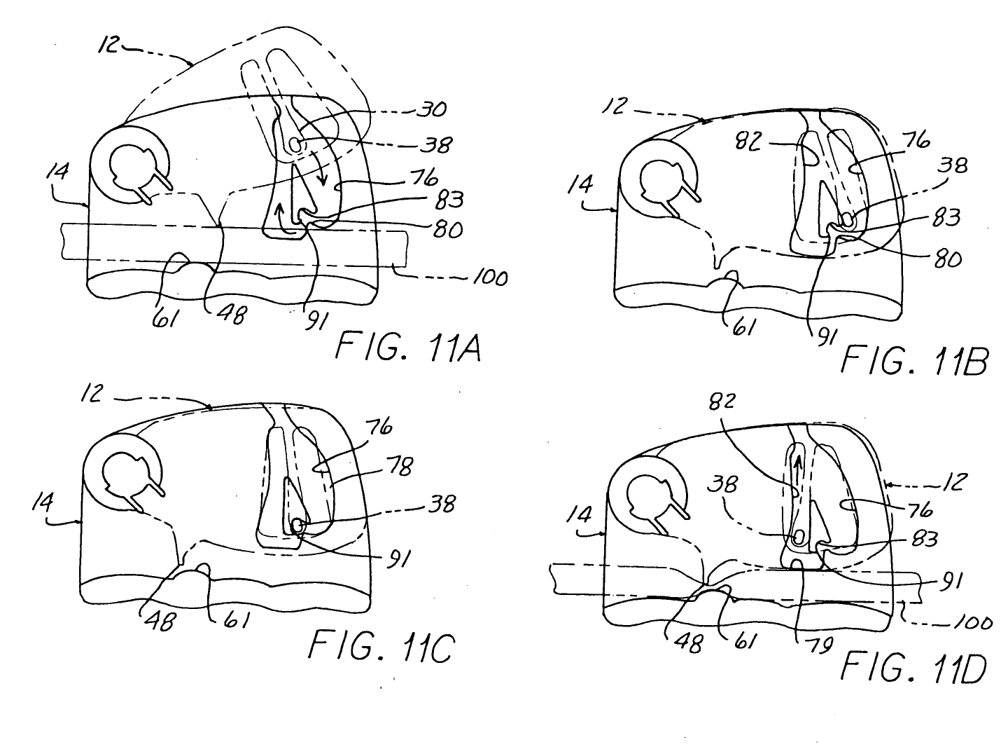

FIGS. 11a-11d show the progression of movement of the upper member 12 relative to the lower member 14 and the movement of the pin 38 of the upper member 12 within the cam race 76 of the lower member 14.

The shape and the pathway of the cam race 76 is precisely configured on the sidewalls 66 of the lower member 14 to control the direction of movement of the pin 38. The entry path 81 to the cam race 76 has a slight angle to lead the pin 38 forward in the direction toward the leading edges 77 and toward the downward arcuate curved portion 78 of the cam race 76 when the upper member 12 is being depressed. The resiliency of the legs 30 allows the legs 30 to flex forward as the pins 38 move to the arcuate curved portions 78. As the upper member 12 is further depressed, the pin 38 travels along the downward arcuate curved portion 78 which then terminates and becomes a slight incline portion directed back toward the pivot end 75 of the lower member 14. The incline portion of the cam race 76 terminates into the notch 83 formed at the single bump 80. The legs 30 are still under tension so that the path of the incline portion and of the configuration of the notch 83 locks the pin 38 therein. This is shown in FIG. 11c.

To further ensure that the pin 38 is in the pin lock position, the cam race 76 forms a catch 91. Upon a subsequent depression on the upper member 12, the pin 38 bypasses the bump 80 and the catch 91 as it travels the downward path to the generally horizontal portion 79. Although the cam race 76 provides for a wide turning radius, the change of direction from the horizontal portion 79 to the vertically straight path portion 82 is abrupt. The position where the horizontal portion 79 meets the vertically straight path portion 82 is the pin bottom stop position. At this position, the tension on the legs 30 has been released. The pin 38 can then be moved upward in the straight path portion 82, also referred to as the pin return ramp position to release the pressure from the ridged portion 48 on the tube 100. The horizontal portion 79 is at a lower level then the slight inclined portion of the cam race 76 so that the pin 38 will continue to travel in a clockwise direction (as viewed in FIGS. 11a-11d) or in a counter clockwise direction if viewing the opposing wall 66 (now shown) and not retraced its path upward into the arcuate curved portion 78. The position of the horizontal portion 79 of the cam race also prevents the pin 38 from bypassing the pin lock position 83 while moving through the cam race 76. As can be seen, the conduit clamp 10 of the present invention can be opened and closed with a finger or thumb push on the shallow depression 18 of the upper member 12.

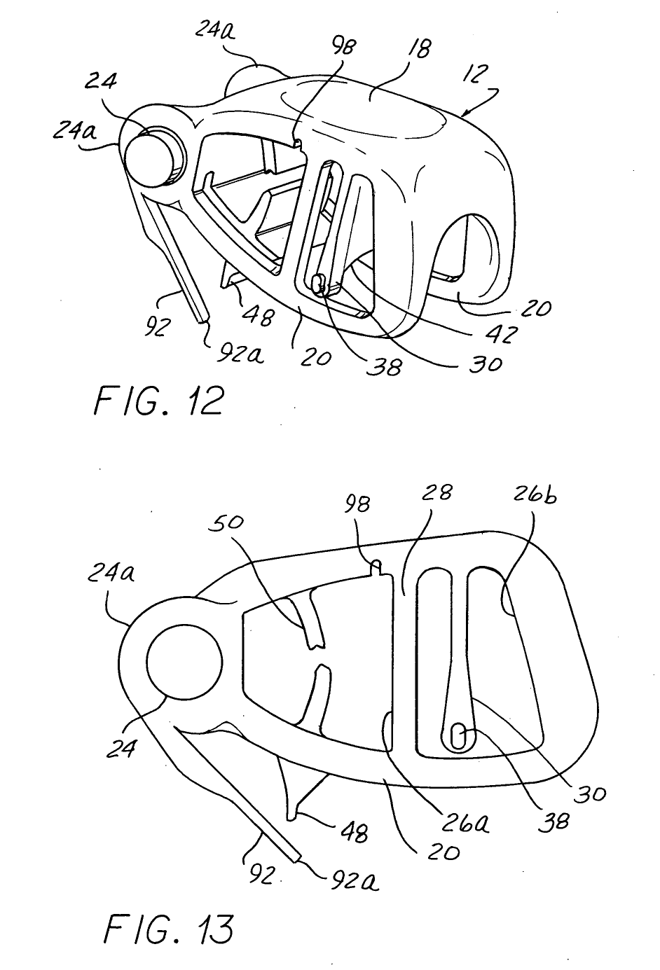

FIGS. 12-18 show another embodiment of the conduit clamp 10 which provides a spring member 92 to bias the clamp 10 in the open position. FIGS. 12 and 13 show a first embodiment of the spring member 92. A spring member 92 extends from a hub 24a which surrounds the lobe 24 formed on each lateral end of the upper member 12. The spring member 92 is integrally formed from the same material during the molding process of the upper member 12. The spring member 92 extends from the hub 24a of the upper member 12 at approximately a 45° angle downwardly. Therefore, each spring member 92 is positioned directly below the sidewall 20 so that the spring member 92 is positioned and moves within the sidewalls 60 of the lower member 14 when the conduit clamp 10 is opened and closed.

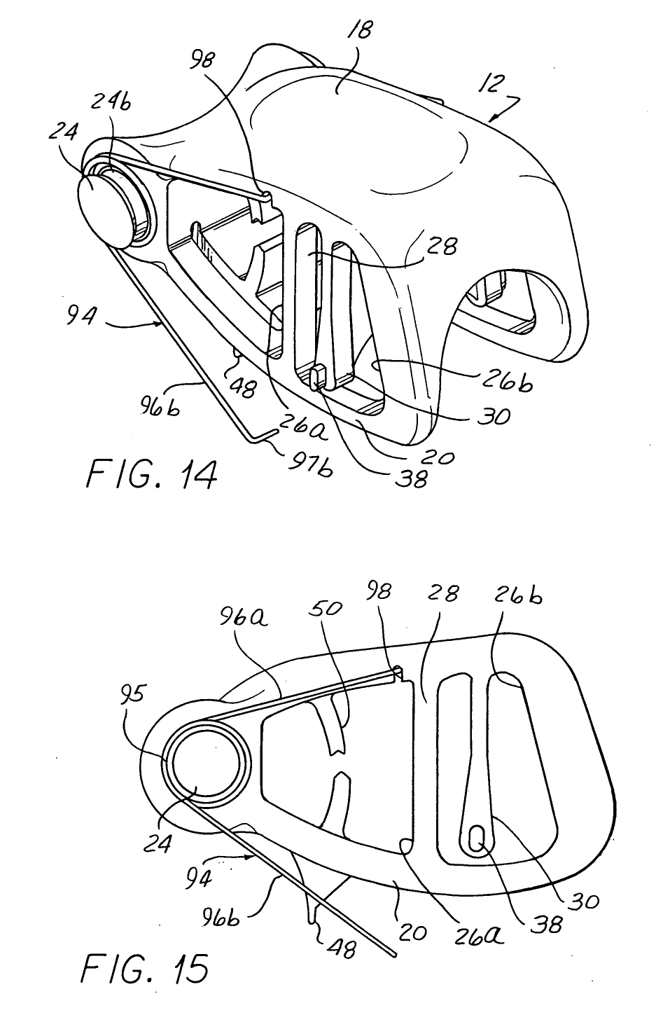

FIGS. 14-18 show a second embodiment of the spring member designated as 94. The second embodiment of the spring member 94 is a metal spring 94 attached to the lobes 24 of the upper member 12. In this embodiment, the upper member 12 has an annular groove 24b formed on each lobe 24. The metal spring 94 is configure to have a center circular portion 95 which is secured within the groove 24b of each lobe 24. The center circular portion 95 of the metal spring 94 has a pair of straight portions 96a, b having short inwardly directed flanges 97a, b at each end. Each metal spring 94 is located outside and adjacent to the sidewalls 20 of the upper member 12. The upper flanged end 97a of each metal spring 94 is disposed within a notch 98 formed in the upper edge of the window 26a in the upper member 12. The disposition of the upper flanged end 97a within notch 98 and the disposition of the center circular portions 95 within groove 24b maintains the metal spring 94 in position on the upper member 12, while the lower straight portion 96b extends downwardly at an approximately 45° angle from the respective lobe 24. The lower flanged ends 97b ride in the track formed by the cutaway 99 in the lower member 14. The cutaway 99 is shown in FIG. 17. As can be seen in FIGS. 14-18, a single metal piece is wound into the aforementioned configuration to form each metal spring 94.

The spring members 92 and 94 are in their normal relaxed position when the clamp 10 is in the open position. The spring members 92 and 94 are in their normal relaxes position when the clamp 10 is in the open position. The spring members 92 and 94 are leaf springs and are in tension when the clamp 10 is in the closed and locked positions. The ends 92a or 97b of the spring members 92 and 94, respectively, act against the bottom interior surface 62 of the lower member 14. When the clamp 10 is closed but no longer in the locked position, the action of the end 92a or 97b forces the upper member 12 to pivot away from the lower member 14.

Each embodiment of the spring members 92 and 94 provide the same benefits to the conduit clamp 10. Each spring member 92, 94 is biased to open the clamp after the clamp 10 is unlocked. The spring 92 or 94 will also keep the clamp 10 open allowing the outwardly extending pins 38 on legs 30 to remain in a relaxed or static position. Further, because the flat plastic spring member 92 is parallel with the walls 20 of the upper member 12 and because the metal spring 94 is positioned outside and adjacent to the walls 20 of the upper member 12, the spring members 92, 94 do not interfere with tube 100 loading.

The conduit clamp 10 of the present invention provides a number of other advantages not seen in the prior art. Smooth exterior surfaces of the conduit clamp 10 prevent the clamp from catching and interfering with other nearby instrumentation. Further, the conduit clamp 10 is manufactured from USP Class VI materials. In particular, the conduit clamp is manufactured from Tefzel® by DuPont Corporation. Tefzel® is a copolymer of ethylene-tetraflourothylene which is autoclavable and can operate in sustained temperatures of 300° F.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A conduit clamp for selectively restricting or closing the fluid path inside a hollow tube, said conduit clamp comprising:
a two-piece construction having an upper member and a lower member releasably and pivotally connectable to each other for connection around the tube for movement between an open position and a closed position, said upper member having a laterally extending pin for disposition in a cam race formed on an interior surface of the lower member, wherein said cam race guides the extending pin during the movement between the open position and the closed position.

2. The conduit of claim 1, wherein the lower member has a U-shaped formation for providing a pathway for the tube.

3. The conduit clamp of claim 1, wherein each laterally extending pin is integrally connected to resilient legs extending from an upper portion of the upper member.

4. The conduit clamp of claim 3, wherein a rib connects the resilient legs together.

5. The conduit clamp of claim 1, wherein the upper member has a center projection for clamping the tube against the lower member.

6. The conduit clamp of claim 5, wherein the lower member has a U-shaped formation with a center inner floor portion and wherein the inner floor portion has a bump for cooperating with the center projection to close the fluid path of the tube.

7. The conduit clamp of claim 2, wherein the cam races in the interior surfaces of the lower member have a pin lock stop portion.

8. The conduit of claim 7, wherein the cam race on the interior surface of the lower member have a pin bottom stop portion and a pin return ramp portion.

9. The conduit clamp of claim 5, wherein the center projection is resilient.

10. The conduit clamp of claim 1, wherein the upper member has an upper surface with a depression therein for manual activation of the extending pins through the cam races.

11. The conduit clamp of claim 8, wherein the cam races have a generally triangular configuration and wherein the pin lock stop portion of the cam race is formed by a bump formation along a lower edge of the cam race.

12. The conduit clamp of claim 1, wherein the upper member has a pair of laterally spaced lobes and the lower member has a pair of laterally spaced apertures, wherein each laterally spaced aperture is positioned for receiving one of the laterally spaced lobes.

13. The conduit clamp of claim 12, wherein the lower member has an entry point and a shallow groove for facilitating the disposition of the lobe into the aperture.

14. The conduit of claim 9, wherein the center projection is connected to a C-spring.

15. A conduit clamp for selectively restricting or closing a fluid path inside a hollow tube, said conduit clamp comprising:
an upper member and a lower member pivotally connected together at one end; the upper member having resilient legs extending from an upper portion of the upper number, wherein each leg has a laterally extending pin end, the lower number having a cam race configured in lateral and opposing walls of the lower member for receiving the pin.

16. The conduit clamp of claim 15, wherein the cam race has a pin lock therein for maintaining the clamp in the closed position.

17. The conduit clamp of claim 16, wherein the cam race has at least one ratchet step for maintaining partial closure of the fluid path in the tube.

18. The conduit clamp of claim 16, wherein the pin lock includes a catch.

19. The conduit clamp of claim 12, wherein the upper member has an integrally formed spring member positioned adjacent to each lobe and formed to extend downwardly toward a bottom interior surface of the lower member, wherein said spring member biases the clamp to an open position.

20. The conduit clamp of claim 12, wherein each lobe has an annular groove thereon and a metal spring is wound around each lobe, said metal spring having a portion extending downwardly toward a bottom interior surface of the lower member, wherein said metal spring biases the clamp to an open position.
